(19) United States
(12) Patent Application Publication
(10) Pub. No.: US 2021/0376375 A1
(43) Pub. Date: Dec. 2, 2021

(54) LITHIUM ION BATTERY, ELECTRODE OF LITHIUM ION BATTERY, AND ELECTRODE MATERIAL

(71) Applicant: Industrial Technology Research Institute, Hsinchu (TW)

(72) Inventors: Yu-Han Lin, Changhua County (TW); Shou-Yi Ho, Taoyuan City (TW); Hung-Chun Wu, Hsinchu County (TW); Jing-Pin Pan, Hsinchu County (TW); Sheng-Wei Kuo, Chiayi County (TW); Kuo-Chan Chiou, Tainan City (TW); Ying-Xuan Lai, Nantou County (TW)

(73) Assignee: Industrial Technology Research Institute, Hsinchu (TW)

(21) Appl. No.: 17/333,021

(22) Filed: May 28, 2021

Related U.S. Application Data
(60) Provisional application No. 63/031,590, filed on May 29, 2020.

(51) Int. Cl. H01M 10/0525; H01M 4/04; H01M 4/62

(52) U.S. Cl. CPC H01M 10/0525; H01M 2004/021; H01M 4/62; H01M 4/048

(57) ABSTRACT

Provided are a lithium ion battery, an electrode of a lithium ion battery, and an electrode material. An electrode material of the lithium ion battery includes electrode active powder and a metal thin film. The metal thin film partially or completely wraps a surface of the electrode active powder, in which the metal thin film includes silver, gold, platinum, palladium, aluminum, magnesium, zinc, tin, or an alloy of the foregoing.

### CROSS REFERENCE TO RELATED APPLICATION

This application claims the priority benefit of U.S. provisional application Ser. No. 63/031,590, filed on May 29, 2020. The entirety of the above-mentioned patent application is hereby incorporated by reference herein and made a part of specification.

### TECHNICAL FIELD

The technical field relates to a lithium ion battery, an electrode of a lithium ion battery, and an electrode material.

### RELATED ART

Lithium ion batteries have become a focus of research and development of new energy sources in countries around the world, due to advantages such as high working potential, high energy density, low pollution, low self-discharge rate and good cycle life. Currently, in addition to being used in mobile phones, wearable devices and other 3C (computer, communications and consumer electronics) products in daily life, lithium ion batteries are gradually being used in the field of transportation tools with the rise of environmental protection awareness.

A lithium ion battery for applications such as a self-driving car, a public transportation vehicle and an energy storage system is required not only to have high capacity, but also to meet the increasing requirements of cycle life and charge/discharge C-rate. However, most positive electrode materials of existing lithium ion batteries include a transition metal element lithium compound. Such materials are characterized by low conductivity and may hardly satisfy the charge/discharge C-rate requirements. Furthermore, due to their low conductivity, problems such as incomplete electrochemical reaction and difficulty in intercalation and deintercalation of lithium ions may occur, causing side reactions in electrodes and electrolyte, thus reducing the cycle life of the lithium ion batteries.

In addition, with regard to the use of a battery or a battery module in a car starter battery, a biggest problem currently encountered is that the use is not practicable at low temperature. The reason is that, when the temperature is lower than 0° C., viscosity of the electrolyte increases such that the migration of lithium ions in the electrolyte is hindered; moreover, electrochemical impedance is greatly increased, with the result that the battery becomes unable to discharge.

### SUMMARY

The disclosure provides an electrode material of a lithium ion battery, in which conductivity of the electrode material can be improved.

The disclosure provides an electrode of a lithium ion battery, in which the electrode has excellent conductivity.

The disclosure provides a lithium ion battery that can be improved in discharge C-rate and has good low temperature discharge performance.

An electrode material of a lithium ion battery of the disclosure includes electrode active powder and a metal thin film. The metal thin film partially or completely wraps a surface of the electrode active powder, in which the metal thin film includes silver, gold, platinum, palladium, aluminum, magnesium, zinc, tin, or an alloy of the foregoing.

A lithium ion battery of the disclosure includes the above-mentioned electrode material that has the electrode active powder and the metal thin film.

An electrode of a lithium ion battery of the disclosure includes an electrode plate and a metal thin film. The metal thin film is formed on a surface of the electrode plate, in which the metal thin film includes silver, gold, platinum, palladium, aluminum, magnesium, zinc, tin, or an alloy of the foregoing.

Another lithium ion battery of the disclosure includes the above-mentioned electrode.

Several exemplary embodiments accompanied with figures are described in detail below to further describe the disclosure in details.

### BRIEF DESCRIPTION OF THE DRAWINGS

FIG. 1 is a schematic three-dimensional view of an electrode material of a lithium ion battery according to a first embodiment of the disclosure.

FIG. 2 is a schematic view of three types of a metal thin film of the disclosure in the shape of a curved surface sheet.

FIG. 3 is a schematic view of a metal thin film of the disclosure in the shape of an irregular surface sheet.

FIG. 4A is a schematic cross-sectional view of an electrode of a lithium ion battery according to a second embodiment of the disclosure.

FIG. 4B is a schematic cross-sectional view of an electrode of a lithium ion battery according to a third embodiment of the disclosure.

FIG. 5A is a scanning electron microscope (SEM) image of electrode active powder of Comparative Example 1.

FIG. 5B is a high-magnification SEM image of FIG. 5A.

FIG. 6A is an SEM image of electrode active powder of Experimental Example 1.

FIG. 6B is a high-magnification SEM image of FIG. 6A.

FIG. 6C is a schematic view of FIG. 6B.

FIG. 7 is an SEM image of an electrode cross-sectional structure of Experimental Example 6.

FIG. 8 is a graph of tableting pressure versus resistivity of Experimental Examples 3 to 4 and Comparative Example 1.

FIG. 9 is a graph of discharge C-rate versus discharge capacity of Experimental Examples 1 to 2 and Comparative Example 1 at room temperature.

FIG. 10 is a graph of discharge C-rate versus discharge capacity of Experimental Example 2 and Comparative Example 1 at low temperature.

FIG. 11 is a graph of discharge C-rate versus capacity retention of Experimental Example 5 and Comparative Example 2 at room temperature.

FIG. 12 is a graph of discharge C-rate versus capacity retention of Experimental Example 6 and Comparative Example 3 at room temperature.

### DESCRIPTION OF THE EMBODIMENTS

Exemplary embodiments of the disclosure will be described comprehensively below with reference to the drawings, but the disclosure may be embodied in many different forms and should not be construed as being limited to the embodiments described herein. For clarity, in the drawings, sizes and thicknesses of regions, portions and layers may not be drawn based on actual scales.

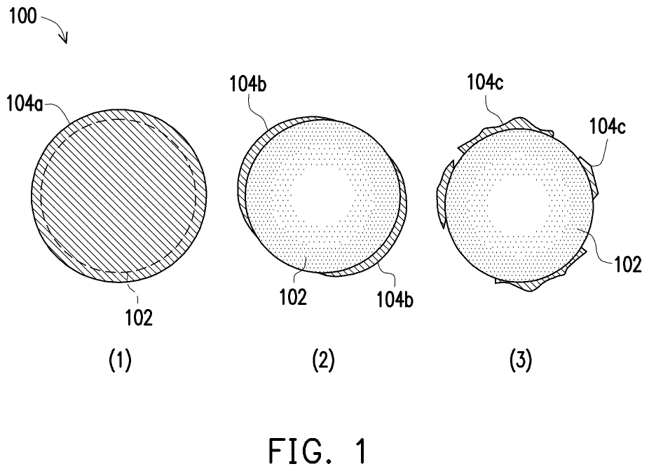

FIG. 1 is a schematic three-dimensional view of an electrode material of a lithium ion battery according to a first embodiment of the disclosure.

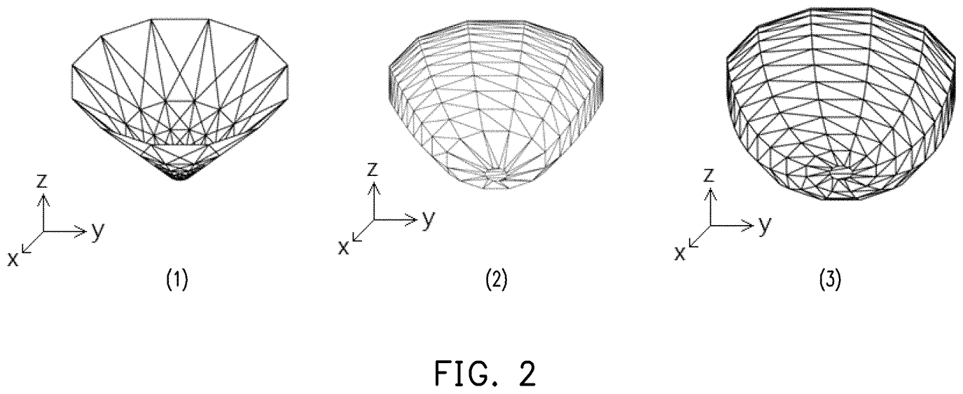

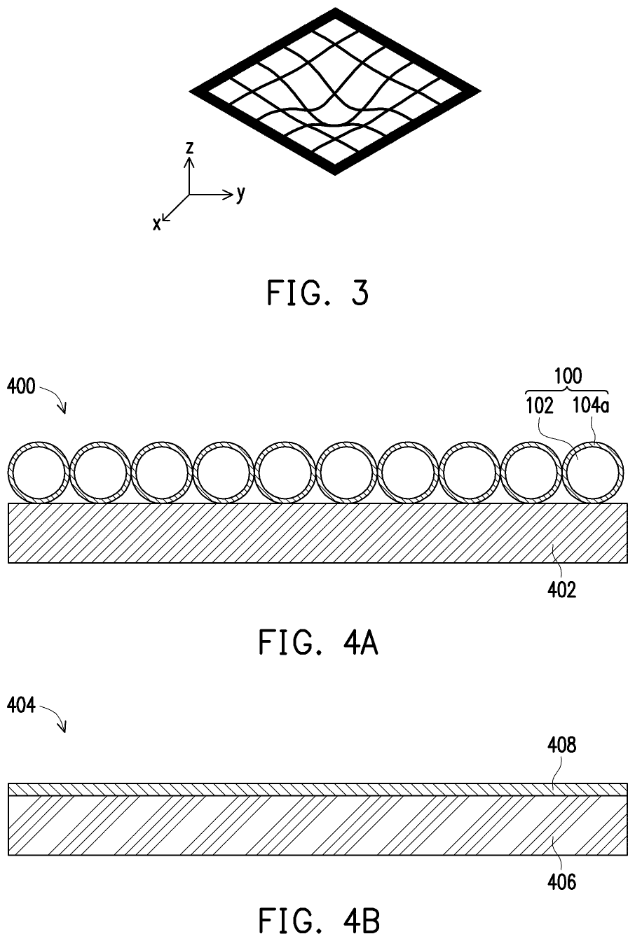

Referring to FIG. 1, an electrode material 100 of the first embodiment includes electrode active powder 102 and metal thin films 104a, 104b and 104c. Among them, the metal thin film 104a completely wraps a surface of the electrode active powder 102. The metal thin film 104b partially wraps the surface of the electrode active powder 102 while taking the shape of a curved surface sheet. The metal thin film 104c partially wraps the surface of the electrode active powder 102 while taking the shape of an irregular surface sheet. The so-called metal “thin film” refers to a thin film made of metal and having a structure similar to that of a two-dimensional material. That is, both the width and length (or area) of the thin film are much greater than the thickness thereof. For example, both the width and length of the thin film are 1000 times or more the thickness of the thin film. In the present embodiment, the metal thin films 104a, 104b and 104c each have a thickness of, for example, 2 nm to 500 nm. With respect to the total weight of the electrode active powder 102 taken as 100 wt %, the weight of the metal thin films 104a, 104b and 104c is in the range of, for example, 0.5 wt % to 5 wt %. The term “curved surface” herein refers to conical surface, arc surface or spherical surface. For example, FIG. 2—(1) represents a conical surface, that is, a body formed by a circle on a plane and a plane defined by all tangents of the circle and a fixed point outside the plane. FIG. 2—(2) represents an arc surface, that is, an image obtained by projection has an arc shape having various different curvatures. FIG. 2—(3) represents a spherical surface, that is, an image obtained by projection has an arc shape having a constant curvature. The term “irregular surface”, as shown in FIG. 3, refers to a surface formed by contacting the surface of the electrode active powder 102 at two or more connection points.

In the first embodiment, the metal thin films 104a, 104b and 104c include silver, gold, platinum, palladium, aluminum, magnesium, zinc, tin, or an alloy of the foregoing. A preparation method thereof is, for example, as follows. Firstly, the electrode active powder 102 is mixed with a composition of an organometallic complex to form a mixture. Then, the organometallic complex is reduced to metal by heating, and the surface of the electrode active powder 102 is wrapped with a metal thin film such as 104a, 104b, or 104c. The form of the wrapping may include pasting or sticking, and the wrapping cannot be peeled off even by ultrasonic oscillation. In an ideal state, the organometallic complex is completely reduced to metal and vaporized, and the metal thin films 104a, 104b and 104c can be obtained having high crystallinity, large crystal grains, and high purity, without the need to perform additional annealing. In other words, the metal in the organometallic complex is the same as the metal in the metal thin films 104a, 104b and 104c. According to the above-mentioned preparation method, there will be no residue or contamination caused in the electrode active powder 102, and additional steps such as neutralization, washing or filtration are not needed, thereby improving the process yield and efficiency. However, there is also a possibility that unreduced organometallic complex may remain on the surface of the electrode active powder 102 in the electrode material 100. With respect to the total weight of the electrode active powder 102 taken as 100 wt %, the weight of the remaining organometallic complex may be in the range of 0.1 wt % or less, such as 0.05 wt % or less or 0.01 wt % or less. The organometallic complex refers to a compound in which carbon and a compound at least containing any one of hydrogen, oxygen, nitrogen and sulfur are used as ligands, and a metal ion is used as the central unit. The term “ligand” refers to a compound that can form one or more bonds with a single metal ion, and examples thereof include an amine, an ether or a thioether. Specific examples thereof include, but not limited to, acetylpyruvate, hexafluoroacetylpyruvate, or hexafluoroacetylpyruvate trialkylphosphine complex. Therefore, the organometallic complex in the first embodiment may contain silver, gold, platinum, palladium, aluminum, magnesium, zinc, and tin, in the ionic state, as the central unit. For example, an organometallic complex containing silver in the ionic state as the central unit may include, but not limited to, an organometallic silver complex represented by the following formula I:

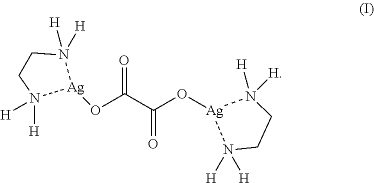

The above-mentioned heating method may include heating by heat transfer, by radiation or by convection; examples thereof include friction and conduction heating during ball milling, and radiation or convection heating such as baking and hot bath. Examples of heating by baking include a drying and heating step during coating of an electrode plate in a general lithium ion battery manufacturing process. Examples of heating by hot bath include a slurry mixing step in the general lithium ion battery manufacturing process. A temperature range of the heating may be from 80° C. to 200° C., such as from 80° C. to 110° C., from 110° C. to 140° C., from 140° C. to 170° C., from 170° C. to 200° C., from 110° C. to 200° C., or from 140° C. to 200° C.

Referring still to FIG. 1, the electrode active powder 102 in the present embodiment refers to a material into/from which lithium ions can be intercalated/deintercalated under the action of an external electric field (charge and discharge). Examples thereof include at least one kind of electrode active material in a group consisting of a compound having a layered structure, a compound having a spinel structure, and a compound having an olivine structure. Specifically, the material of the electrode active powder 102 may be a positive electrode material composed of a transition metal oxide, a transition metal phosphide or a combination thereof, and is, for example, at least one selected from a group consisting of nickel manganese cobalt oxide (NMC), lithium nickel cobalt aluminum oxide (LNCA), lithium iron manganese phosphate (LMFP), lithium cobalt oxide (LCO), lithium manganese oxide (LMO), lithium nickel oxide (LNO), lithium iron phosphate (LFP), lithium titanium oxide (LTO), and niobium titanium oxide (TNO). Alternatively, the material of the electrode active powder 102 may be a negative electrode material composed of a carbon element or a transition metal oxide, and is, for example, at least one selected from a group consisting of an amorphous carbon material, a crystalline carbon material, graphite, lithium titanium oxide, titanium disulfide, and silicon dioxide. In addition, the electrode active powder 102 in FIG. 1 is shown as a whole particle. However, the disclosure is not limited thereto. Since the electrode active powder 102 may include a primary particle or a secondary particle, it may be regarded as powder composed of multiple primary particles. The electrode active powder 102 may be in the shape of a sphere as shown in the figure or in the shape of a prism or irregularities.

FIG. 4A is a schematic cross-sectional view of an electrode of a lithium ion battery according to a second embodiment of the disclosure. The same reference numerals as those in the first embodiment denote the same or similar members, and the same or similar members can be understood with reference to the description of the first embodiment and repeated descriptions will be omitted.

Referring to FIG. 4A, an electrode 400 of the second embodiment is an electrode plate structure for a lithium ion battery. The electrode material 100 includes the electrode active powder 102 and the metal thin film 104a that wraps the surface of the electrode active powder 102. The metal thin film 104a completely wraps the surface of the electrode active powder 102. However, there are also cases where the metal thin film only partially wraps the surface of the electrode active powder 102, as in another example shown in FIG. 1. In the present embodiment, the electrode 400 is, for example, a positive electrode. A preparation method thereof is, for example, as follows. A conductive additive and a binder are added to the electrode material 100 to prepare a slurry. Then, the slurry is coated on a surface of a collector 402, followed by drying and heating. Examples of the conductive additive may include, but not limited to, carbon black (such as Super P), conductive graphite, carbon nanotube, carbon fiber, graphene, or a combination of the above. Examples of the binder may include, but not limited to, poly(vinylidene fluoride) (PVDF), styrene-butadiene rubber (SBR), poly(acrylic acid) (PAA), polyacrylonitrile (PAN), or a combination of the above. The collector 402 may be a foil material such as aluminum, copper, titanium, or stainless steel.

Since the electrode 400 of the lithium ion battery in the second embodiment includes the electrode material 100 of the first embodiment, electron mobility in the electrode active powder 102 is improved due to the excellent conductivity of the electrode material 100, thereby improving discharge power of the lithium ion battery.

FIG. 4B is a schematic cross-sectional view of an electrode of a lithium ion battery according to a third embodiment of the disclosure. The same reference numerals as those in the first embodiment denote the same or similar members, and the same or similar members can be understood with reference to the description of the first embodiment and repeated descriptions will be omitted.

Referring to FIG. 4B, an electrode 404 of the third embodiment is prepared in the manner similar to that of the first embodiment. A metal thin film 408 is formed on a surface of an electrode plate 406 of a lithium ion battery, so as to improve charge and discharge efficiency of the lithium ion battery. For example, firstly, an organometallic complex is coated on the surface of the electrode plate 406. Then, the organometallic complex is reduced to metal by heating, and the metal thin film 408 is thus formed on the surface of the electrode plate 406. The metal thin film 408 includes silver, gold, platinum, palladium, aluminum, magnesium, zinc, tin, or an alloy of the foregoing. The metal thin film 408 has a thickness of, for example, 2 nm to 500 nm. Moreover, in the ideal state, the organometallic complex is completely reduced to metal and vaporized, and the metal thin film 408 can be obtained having high crystallinity, large crystal grains, and high purity, without the need to perform additional annealing. In other words, the metal in the organometallic complex is the same as the metal in the metal thin film 408. According to the above-mentioned preparation method, there will be no residue or contamination caused in the electrode plate 406, and additional steps such as washing are not needed, thereby improving the process yield and efficiency. However, there is also a possibility that a very small amount of unreduced organometallic complex may remain on the surface of the electrode plate 406. The organometallic complex can be understood with reference to the description of the first embodiment and repeated descriptions will be omitted. A composition of the electrode plate 406 includes an electrode material, and a conductive additive and a binder may be added thereto. In some embodiments, the electrode material may be a commonly used electrode active material. In some embodiments, the type of the electrode material can be understood with reference to the description of the first embodiment and repeated descriptions will be omitted.

The following describes several experiments for verification of the effect of the disclosure. However, the disclosure is not limited to the following content.

### EXPERIMENTAL EXAMPLES 1 TO 4

The organometallic silver complex represented by formula I was subjected to kneading with a nickel manganese cobalt oxide (NMC) as electrode active powder, and the organometallic silver complex was coated on a surface of a lithium battery active material. In Experimental Example 1, with respect to the total weight of the NMC taken as 100 wt %, the organometallic silver complex was added to such an extent that 0.5 wt % of Ag was able to be prepared. In Experimental Example 2, with respect to the total weight of the NMC taken as 100 wt %, the organometallic silver complex was added to such an extent that 1 wt % of Ag was able to be prepared. In Experimental Example 3, with respect to the total weight of the NMC taken as 100 wt %, the organometallic silver complex was added to such an extent that 2 wt % of Ag was able to be prepared. In Experimental Example 4, with respect to the total weight of the NMC taken as 100 wt %, the organometallic silver complex was added to such an extent that 5 wt % of Ag was able to be prepared. Then, a slurry containing the organometallic silver complex was heated at 130° C., such that the organometallic silver complex was reduced to metallic silver, and an electrode material was obtained in which the surface of the NMC was wrapped with metallic silver.

### COMPARATIVE EXAMPLE 1

NMC powder was directly used as an electrode material, and this is equivalent to that the Ag content was 0 wt %.

### EXPERIMENTAL EXAMPLE 5

An electrode material was prepared in the same manner as in Experimental Example 1, except that lithium iron phosphate (LFP) was used as the electrode active powder.

### COMPARATIVE EXAMPLE 2

LFP powder was directly used as an electrode material, and this is equivalent to that the Ag content was 0 wt %.

### EXPERIMENTAL EXAMPLE 6

NMC powder, styrene-butadiene rubber (SBR) and conductive carbon black Super P were mixed in a weight ratio of 95:2:3 to prepare a slurry. Then, the slurry was coated on a surface of an aluminum collector, followed by drying and heating to obtain a positive electrode plate. Then, the organometallic silver complex represented by formula I was coated on a surface of the positive electrode plate by slit coating, followed by reduction by heating at 130° C., such that the surface of the positive electrode plate was coated with metallic silver, and the resultant served as Experimental Example 6.

### COMPARATIVE EXAMPLE 3

In Comparative Example 3, a positive electrode plate was prepared by the method of Experimental Example 6. However, no organometallic silver complex was coated on the positive electrode plate. This is equivalent to that there was no organometallic silver coating on the surface.

<Image Analysis>

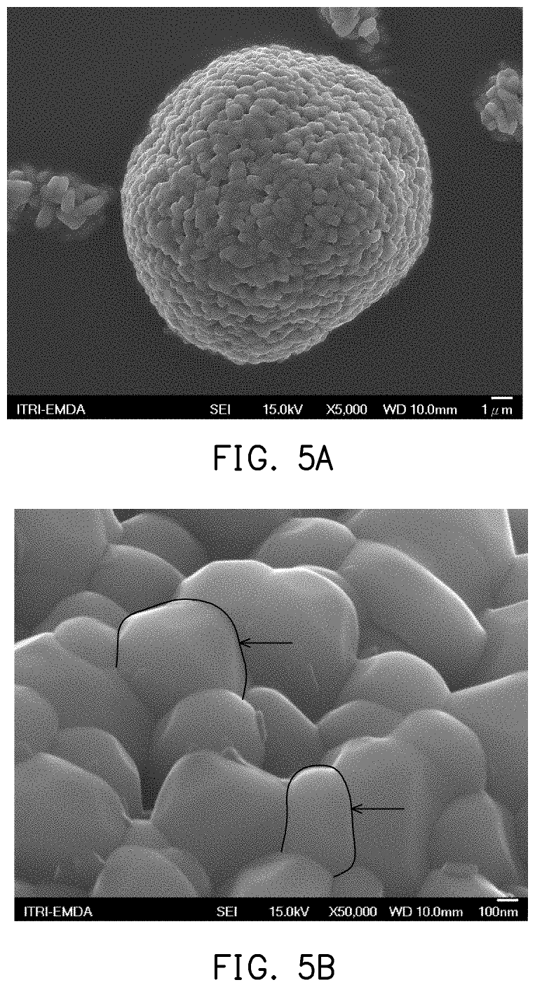

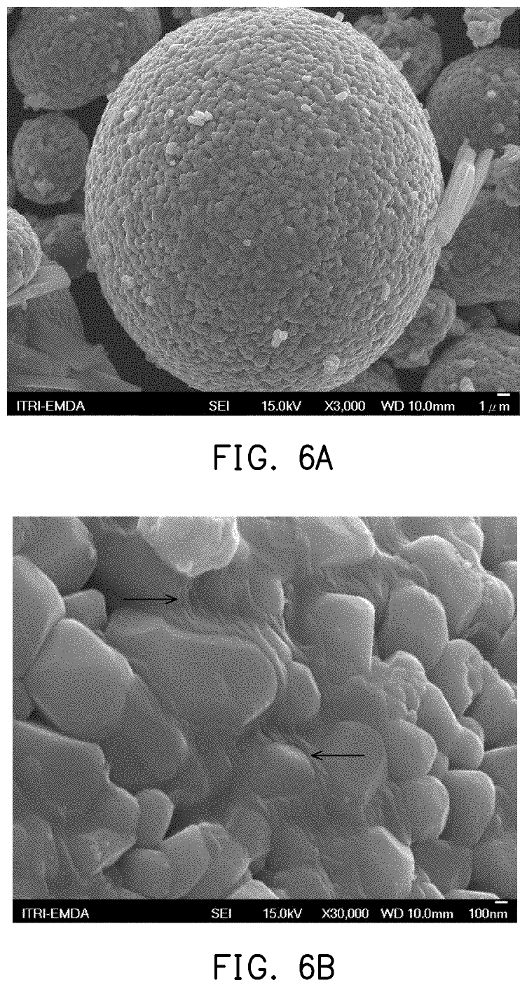

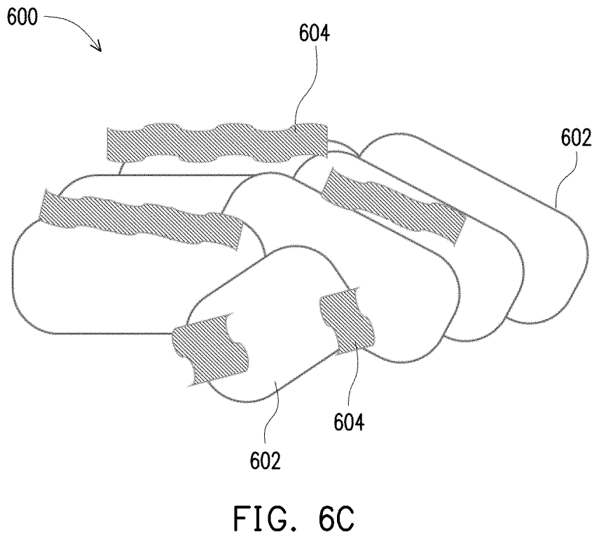

The electrode materials of Comparative Example 1 and Experimental Example 1 were observed using a scanning electron microscope (SEM), and the results are shown in FIG. 5A, FIG. 5B, FIG. 6A, and FIG. 6B, respectively. FIG. 5A and FIG. 5B are SEM images of the NMC powder of Comparative Example 1. It can be seen that the NMC powder included a secondary particle composed of multiple primary particles, and there was a clear interface between each of the primary particles (see portions pointed by arrows in FIG. 5B). FIG. 6A and FIG. 6B are SEM images of the electrode material of Experimental Example 1. As can be seen from FIG. 6B, after the surface of the NMC powder was wrapped with the metal (silver) thin film, the interface between the particles on the powder surface became unclear (see portions pointed by arrows in FIG. 6B). For clarity of the structure of FIG. 6B, please refer to FIG. 6C. In an electrode material 600, 602 denotes the primary particles of the electrode active powder, and 604 denotes the metal thin film that partially covers a surface of the primary particles 602 of the electrode active powder.

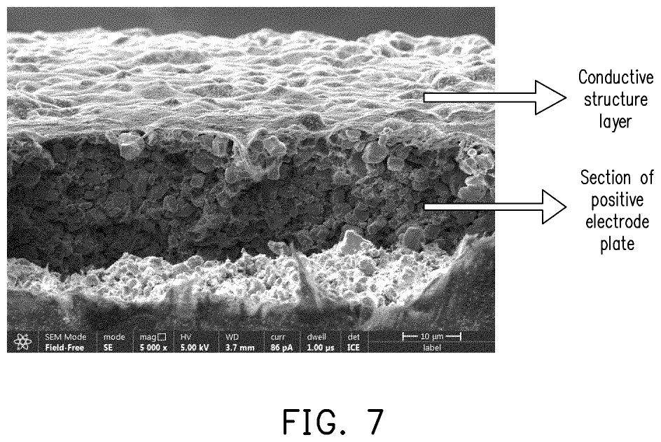

In addition, the electrode of Experimental Example 6 was observed using an SEM. It can be seen from an SEM image (see FIG. 7) that, in the cross-sectional structure of Experimental Example 6, the surface of the positive electrode plate was covered with a thin film having a thickness of about 400 nm.

<Conductivity Testing of Electrode Material>

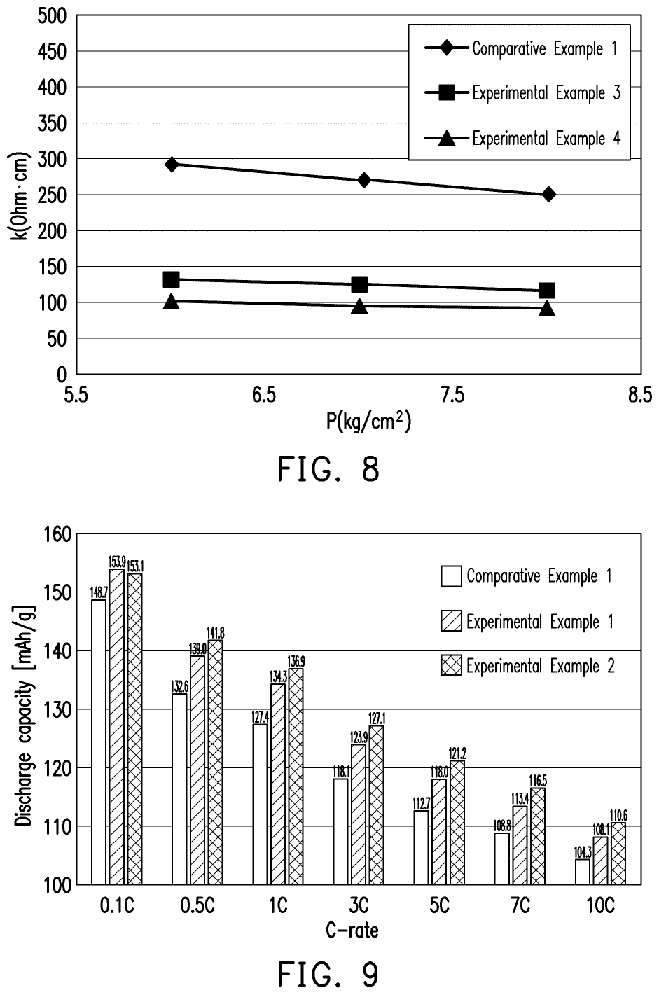

A testing method was as follows. The electrode materials (powder) of Experimental Examples 3 to 4 and Comparative Example 1 were compressed into tablets using a tableting apparatus, followed by being subjected to a powder impedance test, and the results are shown in FIG. 8.

As can be seen from FIG. 8, when tableting pressure (P) was changed, the electrode materials of Experimental Examples 3 to 4 both had significantly lower resistivity (k) than the electrode material of Comparative Example 1. Thus, by wrapping the surface of the electrode active powder with a metal thin film, conductivity can be improved.

<Electrode Plate Impedance Testing 1>

A preparation method was as follows. The electrode materials (powder) of Experimental Example 2 and Comparative Example 1 were respectively mixed with styrene-butadiene rubber (SBR) and conductive carbon black Super P in a weight ratio of 95:2:3 to prepare a slurry. Then, the slurry was coated on a surface of an aluminum collector, followed by drying and heating to obtain two electrode plates.

Then, the electrode plates were separately subjected to an electrode plate impedance test, and the results are shown in Table 1 below.

TABLE 1

| Comparative | Experimental |
|---|---|
| Example 1 | Example 2 |
| Electrode plate | Electrode plate |
| impedance (mΩ) | impedance (mΩ) |
| 0.612 | 0.239 |
| 0.571 | 0.247 |
| 0.512 | 0.255 |
| 0.494 | 0.263 |
| 0.479 | 0.261 |
| 0.597 | 0.23 |
| 0.577 | 0.244 |
| 0.585 | 0.252 |

As can be seen from Table 1 above, the electrode plate wrapped with the metal thin film (that is, the electrode plate in which the surface of the electrode active powder was wrapped with the metal thin film) had lower impedance than the unmodified electrode plate (that is, the electrode plate in which the surface of the electrode active powder underwent no modification).

<Room Temperature Battery Performance Comparison 1>

A preparation method was as follows. Firstly, positive electrode plates were prepared using the electrode materials (powder) of Experimental Examples 1 to 2 and Comparative Example 1 according to the method described in the Electrode Plate Impedance Testing 1. Then, batteries were fabricated. The fabrication steps were as follows:

(1) A positive electrode plate was cut into a 1.9 cm*1.9 cm size, and a positive electrode conductive handle was reserved.

(2) Lithium metal was cut into a 2.5 cm*2.5 cm size, and a nickel handle was used as a negative electrode conductive handle.

(3) A separator was cut into a 3 cm*3 cm size.

(4) Two pieces of the separator described in step 3 covered the positive electrode plate described in step 1 on both sides, thereby completing a positive electrode plate with separators on both surfaces.

(5) The positive electrode plate described in step 4 that contained the separators was wrapped with the lithium metal described in step 2, thereby completing a battery roll including lithium metal on the outermost side, two separators in the middle layer, and a positive electrode plate in the center layer.

(6) The battery roll described in step 5 was encapsulated with an aluminum plastic film, and 0.5 g of electrolyte was added thereto, thereby completing fabrication of a battery of a 4 cm*6 cm size.

(7) The battery described in step 6 was subjected to electrochemical formation, and various subsequent battery performance tests were started.

A testing method was as follows. Each battery was subjected to capacity testing at different discharge C-rates at room temperature (about 25° C.), and the results are shown in FIG. 9.

As can be seen from FIG. 9, the batteries including the electrode materials of Experimental Examples 1 to 2 had better C-rate performance at room temperature than the battery including the unmodified electrode material of Comparative Example 1.

<Low Temperature Battery Performance Comparison>

A preparation method was as follows. Batteries were prepared in the same manner as described in the Room Temperature Battery Performance Comparison 1 using the electrode materials (powder) of Experimental Example 2 and Comparative Example 1.

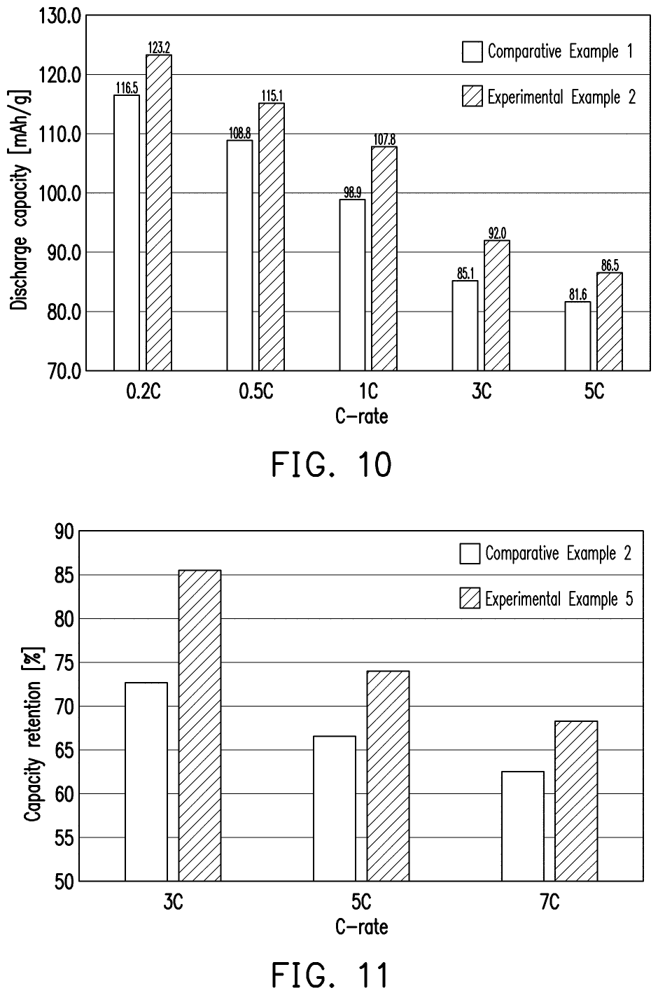

A testing method was as follows. Each battery was subjected to capacity testing at different discharge C-rates at low temperature (about 0° C.), and the results are shown in FIG. 10.

As can be seen from FIG. 10, the battery including the electrode material of Experimental Example 2 also had better C-rate performance at low temperature than the battery including the unmodified electrode material of Comparative Example 1.

<Electrode Plate Impedance Testing 2>

A preparation method was as follows. Two electrode plates were fabricated according to the method described in the Electrode Plate Impedance Testing 1 using the electrode materials (powder) of Experimental Example 5 and Comparative Example 2, respectively.

Then, the electrode plates were separately subjected to an electrode plate impedance test, and the results are shown in Table 2 below.

TABLE 2

| Comparative | Experimental |
|---|---|
| Example 2 | Example 5 |
| Electrode plate | Electrode plate |
| impedance (mΩ) | impedance (mΩ) |
| 0.502 | 0.437 |
| 0.521 | 0.472 |
| 0.505 | 0.401 |
| 0.529 | 0.482 |
| 0.496 | 0.398 |
| 0.502 | 0.454 |
| 0.502 | 0.437 |
| 0.521 | 0.472 |

As can be seen from Table 2 above, even if the material of the electrode active powder was changed, the electrode plate having the powder surface wrapped with the metal thin film had lower impedance than the electrode plate having unmodified powder surface.

<Room Temperature Battery Performance Comparison 2>

A preparation method was as follows. Batteries were prepared according to the method described in the Room Temperature Battery Performance Comparison 1 using the electrode materials (powder) of Experimental Example 5 and Comparative Example 2.

A testing method was as follows. Each battery was subjected to capacity testing at different discharge C-rates at room temperature, and the results are shown in FIG. 11.

As can be seen from FIG. 11, the battery including the electrode material of Experimental Example 5 had better C-rate performance at room temperature than the battery including the unmodified electrode material of Comparative Example 2.

<Room Temperature Battery Performance Comparison 3>

A preparation method was as follows. Batteries were prepared according to the battery preparation method described in the Room Temperature Battery Performance Comparison 1 using the electrodes of Experimental Example 6 and Comparative Example 3.

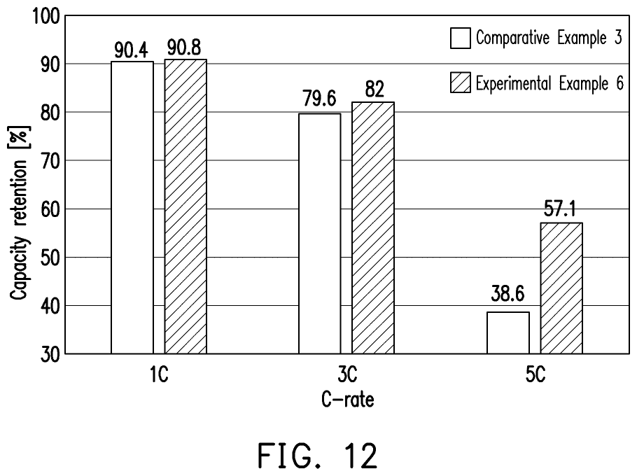

A testing method was as follows. Each battery was subjected to capacity testing at different discharge C-rates at room temperature, and the results are shown in Table 3 below and FIG. 12.

TABLE 3

| | Comparative | | Experimental | |
|---|---|---|---|---|
| | Example 3 | | Example 6 | |
| | Sample No. | | | |
| | 1 | 2 | 3 | 4 |
| | Discharge capacity (mAh/g) | | | |
| | 174.0 | 174.3 | 174.0 | 174.1 |
| | Capacity retention (%) | | | |
| 1C | 90.4 | 90.8 | 90.8 | 88.8 |
| 3C | 79.6 | 78.9 | 82.0 | 81.9 |
| 5C | 38.6 | 38.7 | 57.1 | 56.1 |

As can be seen from Table 3 and FIG. 12, Experimental Example 6 in which the electrode plate was coated with metal had higher capacity retention under large current discharge.

In summary, in the disclosure, the organometallic complex is applied in modifying the surface of the electrode active powder, such that the surface of the electrode active powder is partially or completely wrapped with the metal thin film, so as to reduce interfacial impedance between powders. Therefore, in the disclosure, the conductivity of active powder can be improved by a simplified manufacturing process, thus improving the discharge power of the lithium ion battery. In addition, in the disclosure, by coating the organometallic complex on the surface of the electrode plate, the capacity retention of the lithium ion battery under large current discharge can also be improved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An electrode material of a lithium ion battery, comprising:
electrode active powder; and
a metal thin film, partially or completely wrapping a surface of the electrode active powder, wherein the metal thin film comprises silver, gold, platinum, palladium, aluminum, magnesium, zinc, tin, or an alloy of the foregoing.

2. The electrode material of a lithium ion battery according to claim 1, wherein a weight of the metal thin film is in a range of 0.5 wt % to 5 wt % with respect to a total weight of the electrode active powder taken as 100 wt %.

3. The electrode material of a lithium ion battery according to claim 1, further comprising an organometallic complex located on the surface of the electrode active powder, wherein a metal in the organometallic complex is the same as a metal in the metal thin film.

4. The electrode material of a lithium ion battery according to claim 1, wherein a material of the electrode active powder is at least one selected from a group consisting of a compound having a layered structure, a compound having a spinel structure, and a compound having an olivine structure.

5. The electrode material of a lithium ion battery according to claim 4, wherein the material of the electrode active powder is at least one selected from a group consisting of nickel manganese cobalt oxide (NMC), lithium nickel cobalt aluminum oxide (LNCA), lithium iron manganese phosphate (LMFP), lithium cobalt oxide (LCO), lithium manganese oxide (LMO), lithium nickel oxide (LNO), lithium iron phosphate (LFP), lithium titanium oxide (LTO), and niobium titanium oxide (TNO).

6. The electrode material of a lithium ion battery according to claim 1, wherein a material of the electrode active powder is at least one selected from a group consisting of an amorphous carbon material, a crystalline carbon material, graphite, lithium titanium oxide, titanium disulfide, and silicon dioxide.

7. The electrode material of a lithium ion battery according to claim 1, wherein the metal thin film has a thickness of 2 nm to 500 nm.

8. The electrode material of a lithium ion battery according to claim 1, wherein a shape of the metal thin film comprises a curved surface sheet shape or an irregular surface sheet shape.

9. The electrode material of a lithium ion battery according to claim 1, wherein the electrode active powder comprises a primary particle or a secondary particle.

10. The electrode material of a lithium ion battery according to claim 1, wherein a shape of the electrode active powder comprises a sphere, a prism, or irregular shapes.

11. A lithium ion battery, comprising the electrode material according to claim 1.

12. The lithium ion battery according to claim 11, wherein the electrode material is a material of a positive electrode or a negative electrode.

13. The lithium ion battery according to claim 12, wherein the positive electrode and the negative electrode each independently comprise a conductive additive and a binder.

14. The lithium ion battery according to claim 13, wherein the conductive additive comprises carbon black, conductive graphite, carbon nanotube, carbon fiber, or graphene.

15. The lithium ion battery according to claim 13, wherein the binder comprises poly(vinylidene fluoride) (PVDF), styrene-butadiene rubber (SBR), poly(acrylic acid) (PAA), or polyacrylonitrile (PAN).

16. An electrode of a lithium ion battery, comprising:
an electrode plate; and
a first metal thin film, formed on a surface of the electrode plate, wherein the first metal thin film comprises silver, gold, platinum, palladium, aluminum, magnesium, zinc, tin, or an alloy of the foregoing.

17. The electrode of a lithium ion battery according to claim 16, further comprising an organometallic complex located on the surface of the electrode plate, wherein a metal in the organometallic complex is the same as a metal in the first metal thin film.

18. The electrode of a lithium ion battery according to claim 16, wherein a composition of the electrode plate comprises an electrode material.

19. The electrode of a lithium ion battery according to claim 18, wherein the electrode material comprises:
electrode active powder; and
a second metal thin film, partially or completely wrapping a surface of the electrode active powder, wherein the second metal thin film comprises silver, gold, platinum, palladium, aluminum, magnesium, zinc, tin, or an alloy of the foregoing.

20. The electrode of a lithium ion battery according to claim 16, wherein the first metal thin film has a thickness of 2 nm to 500 nm.

21. A lithium ion battery, comprising the electrode according to claim 16.

22. The lithium ion battery according to claim 21, wherein the electrode is a positive electrode or a negative electrode.
